(19) United States
(12) Patent Application Publication
(10) Pub. No.: US 2010/0007788 A1
(43) Pub. Date: Jan. 14, 2010

(54) Method and apparatus for managing non-used areas of a digital video display when video of other aspect ratios are being displayed

(75) Inventors: Man Kit Lee, Temple City, CA (US); Kenneth Lowe, San Juan Capistrano, CA (US)

Correspondence Address: Law Office of Scott C Harris Inc, PO Box 1389, Rancho Santa Fe, CA, 92067, US

(73) Assignee: VIZIO, INC., Irvine, CA (US)

(21) Appl. No.: 12/170,360

(22) Filed: Jul. 9, 2008

(51) Int. Cl. H04N 7/01

(52) U.S. Cl. 348/445; 348/E07.003

(57) ABSTRACT

A system that intelligently manages the empty spaces on a digital television screen when video images other than the native aspect ratio of the screen are being displayed. These spaces are typically presented as black bars on either side and/or above and below a video image that is not the same aspect ratio as the aspect ratio that is native to the display screen. The invention allows for non-contrasting bars to minimize burning of the bar image onto screens that are susceptible to retention of a high contrast image. The invention also allows for the display of metadata such as current program related information and other data that may be of interest to the viewer.

### FIELD OF THE INVENTION

The present invention relates to digital televisions and their display screens.

### BACKGROUND

Viewers of large screen high definition televisions often view programs that are not formatted for the high definition screen. Black bars may be used to fill out or pad out the areas on the screen where video is not being displayed. These bars are needed because standard definition and high definition television screens have different aspect ratios, where the aspect ratio of the screens is expressed as the ratio of the width to it height. The aspect ratio of standard definition legacy screens is 4:3; comparing with the 16:9 aspect ratios of high definition screens is 16:9.

When standard definition video, or video that was produced from film, is displayed on high definition screens the image generally is scaled such that the height of the image is the same as the height of the screen, but the width is not sufficient to fill the width of the screen. There are two possibilities to fill the width of the screen. The first is to stretch the width of the video image.

There are several algorithms used by different television manufacturers for stretching the image. A first is to stretch the image such that everything is wider. This generally results in a less than satisfactory image. A second stretch algorithm is to stretch the left and right thirds of the image to fill the width of the screen. This algorithm leaves the center third of the image undistorted and the other thirds distorted. Viewers may find this stretch algorithm less annoying than having the entire image stretched and distorted.

Another scheme maintains the same or native aspect ratio of the image. This allows the image to be scaled to fill the vertical space of the screen and leaves empty spaces on either sides of the image. Televisions generally substitute black as the fill color for these empty vertical spaces or bars. There is a drawback to this scheme for glass CRT screens or plasma screens. High contrast images such as the black bars will, over time, cause an image to be burned into the screen. When the television is off or when it returns to displaying a native aspect ratio image, a latent image of the bars may be visible over the current image.

Prior art exists for the scaling of video images that are formatted with an aspect ratio other than that used for the display screen on which the image will be displayed.

Black bars can be displayed on a television screen where the image is either shorter in height than the screen more commonly referred to as letter box display mode; or narrower than the width of the screen more commonly referred to as pillar display mode. The bars are there because the image does not fit the screen but this allows the image to be displayed without distortion. This does not address the issue of display screen burn or any solution to that issue.

Because of the wide variety of aspect ratios used in film production the use of black bars in letterbox or pillar or windows display mode is not likely to go away.

The article presented at http://en.wikipedia.org/wiki/Letterbox speaks to the actual mode of letterbox and pillar mode but does not address the issue of screen burn in.

None of the articles in literature suggest any use for the black bars other than padding between the image being displayed and the edges of the display screen.

Prior art has typically been concerned with how a non-native aspect ratio video or still static image is displayed on a television screen. The schemes disclose in general minimizing the amount of distortion introduced when an image is scaled or compressed in an attempt to maximize the area of the image onto the displayable area of the screen. The disclosures allude to black bars being used to fill the areas between the image and the edge of the screen. The disclosures do not address the issues around the susceptibility of screens to retain the outline or the entire area of a high contrast image on the display screen nor are the prior art disclosures concerned with using the areas of the screen where the black bars are displayed for other purposes as is the current techniques.

### SUMMARY OF THE INVENTION

The current invention addresses the issues of displaying filler images on a digital television screen that are necessary when a video or static image is being displayed that is not the same aspect ratio as the native aspect ratio of the display screen.

Embodiments disclose a method that eliminates the possibility of burning in the image of a “black bar” normally used as the filler bar for flushing out non-native aspect ratio images and for display of metadata in these filler area of the display screen.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 depicts a 16:9 aspect ratio display screen with a non 16:9 aspect ratio image being displayed in window mode with black bars padding out the image.

FIG. 2 depicts a 16:9 aspect ratio display screen with a non 16:9 aspect ratio image being displayed in window mode with color gradient bars padding out the image.

FIG. 3 depicts a 16:9 aspect ratio display screen with a non 16:9 aspect ratio image being displayed in pillar mode with black bars padding out the image.

FIG. 4 depicts a 16:9 aspect ratio display screen with a non 16:9 aspect ratio image being displayed in pillar mode with color gradient bars padding out the image.

FIG. 5 depicts a 16:9 aspect ratio display screen with a non 16:9 aspect ratio image being displayed in letter mode with black bars padding out the image.

FIG. 6 depicts a 16:9 aspect ratio display screen with a non 16:9 aspect ratio image being displayed in letter mode with color gradient bars padding out the image.

FIG. 7 depicts a 16:9 aspect ratio display screen with a non 16:9 aspect ratio image being displayed in letter mode with color gradient bars padding out the image and a stock ticker application displaying stock quotes above and below the non 16:9 aspect ratio image.

FIG. 8 depicts a 16:9 aspect ratio display screen with a non 16:9 aspect ratio image being displayed in window mode with color gradient bars padding out the image and a weather forecast application displaying a 5 day forecast below the non 16:9 aspect ratio image.

FIG. 9 depicts a 16:9 aspect ratio display screen with a non 16:9 aspect ratio image being displayed in pillar mode with color gradient bars padding out the image and a logo application displaying a company logo to the left and right of the non 16:9 aspect ratio image.

FIG. 10 depicts a flowchart with the basic logic for detecting and determining the aspect ratio of the next image or frame to be displayed on the screen and patterns and metadata to be displayed with non-native aspect ratio images on a display screen.

FIG. 11 depicts the functional blocks of a digital television with 1 embodiment of the invention.

### DETAILED DESCRIPTION OF THE INVENTION

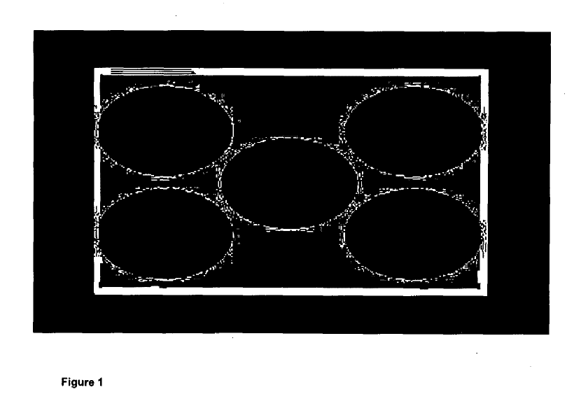

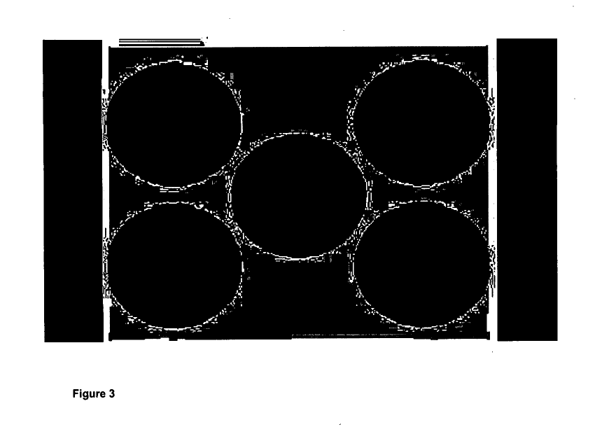

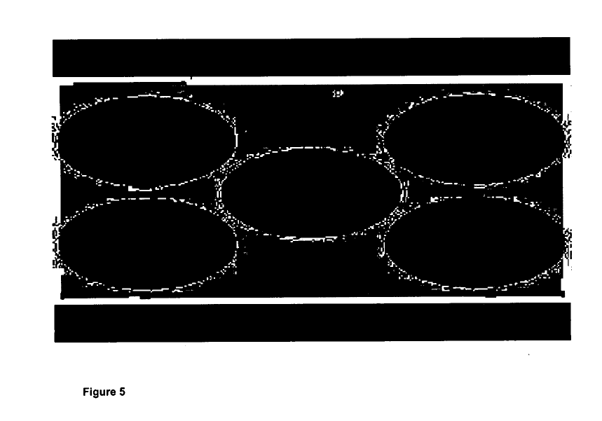

Basic modes of displaying non native aspect ratio images may include Letter mode (FIG. 5), Window mode (FIG. 1), and Pillar mode (FIG. 3). Current digital televisions display black bars to fill in blank areas for each of these display modes and thus make CRT and plasma display screens subject to burn-in. Embodiments as disclosed herein address the issue of burn-in and high contrast and opens the opportunity to make use of the non video areas of the display screens when video or images of other than the native aspect ratio are being displayed.

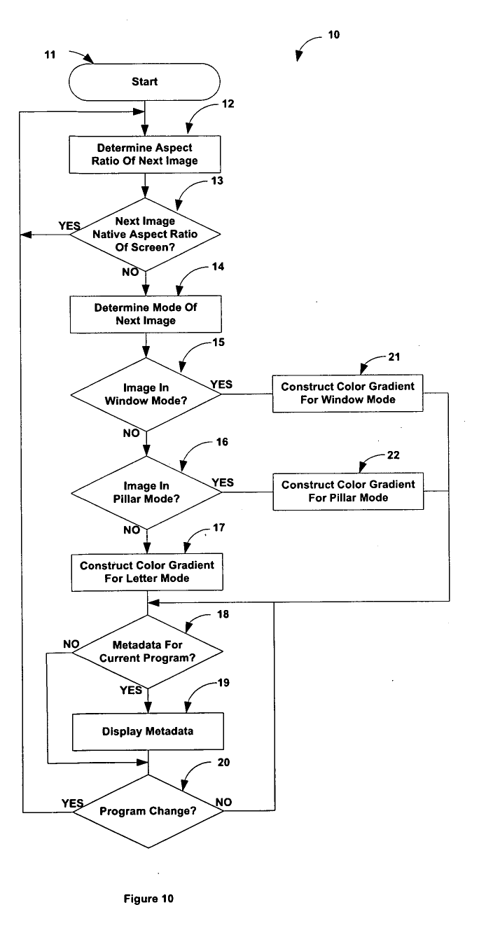

An embodiment 10 is illustrated through the use of the flowchart shown as FIG. 10. A next image, video or static, is prepared to be displayed on the digital television screen. The Determine Aspect Ratio Of Next Image 12 determines its aspect ratio. Step 13 then determines if the next image is not the same as the native aspect ratio of the display screen.

This determination may be through any of a plurality of methodologies such as real-time examination of the video memory for the next displayable image or through the monitoring of a hardware electrical signal that is of a particular value when a non native aspect ratio image has been detected.

Process block, Determine Aspect Ratio Of Next Image 12, makes a determination of the aspect ratio of the next image to be displayed on the digital television display panel.

When step 13 determines that the next image is the same as the native aspect ratio, the operation continues. Otherwise, the step sets a notification if the next image to be displayed is determined to not be the same as the native aspect ratio of the display screen.

If decision block, Next Image Native Aspect Ration Of Screen? 13, is notified that the current image is the same as the native aspect ratio image of the screen, control will be transferred to Determine Aspect Ratio Of Display Image 12 which waits for the next displayable image frame to be constructed and then determines if the aspect ratio of the image is not the same as the native aspect ratio of the screen.

If Next Image Native Aspect Ration Of Screen? 13 is notified that the next image to be displayed is not the same aspect ratio as the native aspect ratio of the screen, control will fall through to Determine Mode Of Next Image 14.

Process block, Determine Mode Of Next Image 14, determines if the next image to be displayed will be displayed in Window Mode, Pillar Mode, or Letter Mode.

Once Determine Mode Of Next Image 14 has determined the display mode, control falls through to decision block Image In Window Mode? 15.

If the image for the next frame to be displayed is not in Window Mode then control falls through to decision block Image In Pillar Mode? 16.

If the image for the next frame to be displayed is not in Pillar Mode then control falls through to Construct Color Gradient For Letter Mode 17.

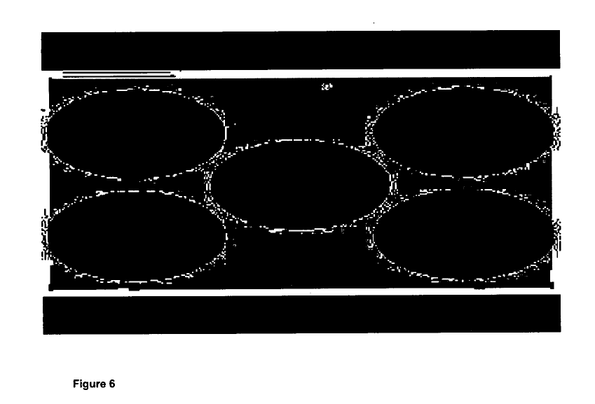

Process block, Construct Color Gradient For Letter Mode 17, displays a predetermined color gradient pattern above and below the image before the image is painted onto the display panel. The varying color gradient can be, for example, a varying hue, and/or a intensity of the same color. FIG. 5 is an example of letter mode display of an image where the bars above and below the image are colored black and FIG. 6 is an example of letter mode display where the invention has displayed a color gradient pattern in place of the normal black bars above and below the image. After the correctly shaped color gradient bars have been added to the next display image instead of the normally used black bars, control will be passed to decision block, Metadata For Current Program? 18.

If decision block, Image In Window Mode? 15, determined that the next image to be displayed is in window mode then control will be transferred to Construct Color Gradient For Window Mode 21.

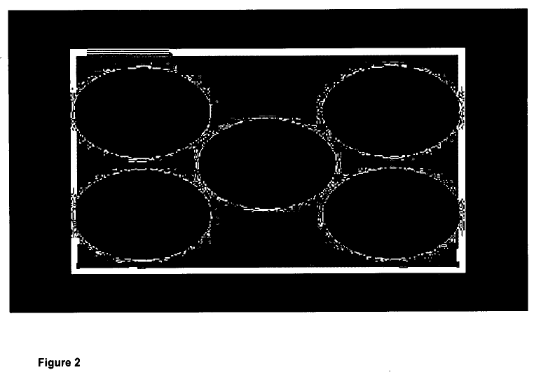

Process block, Construct Color Gradient For Window Mode 21, displays a predetermined color gradient pattern above and below and to either side of the image before the image is painted onto the display panel. FIG. 1 is an example of window mode display of an image where the bars above and below and to either side of the image are colored black and FIG. 2 is an example of letter mode display where an embodiment has displayed a color gradient pattern in place of the normal black bars above and below and to either side of the image. After the correctly shaped color gradient bars have been added to the next display image instead of the normally used black bars, control is passed to decision block, Metadata For Current Program? 18.

If decision block, Image In Pillar Mode? 16, determined that the next image to be displayed is in pillar mode then control will be transferred to Construct Color Gradient For Pillar Mode 22.

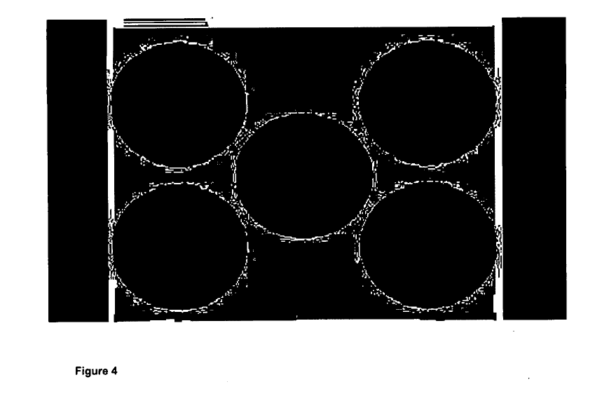

Process block, Construct Color Gradient For Pillar Mode 22, will display a predetermined color gradient pattern to either side of the image before the image is painted onto the display panel. FIG. 3 is an example of pillar mode display of an image where the bars to either side of the image are colored black and FIG. 4 is an example of pillar mode display where the embodiment displays a color gradient pattern in place of the normal black bars to either side of the image.

After the correctly shaped color gradient bars have been added to the next display image instead of the normally used black bars, control is passed to decision block, Metadata For Current Program? 18. Metadata For Current Program? 18 will, if there is associated metadata tagged for the current program then control will fall through to Display Metadata 19. Metadata for any given program may be sourced from a plurality of sources such as the private data area contained in PSIP data which is transmitted as part of MPEG-2 transport streams sourced by broadcasters or may be sourced from the content provider's internet site or sourced from files that were previously transferred to the digital television over a wired or wireless network or from some other yet to be determined source.

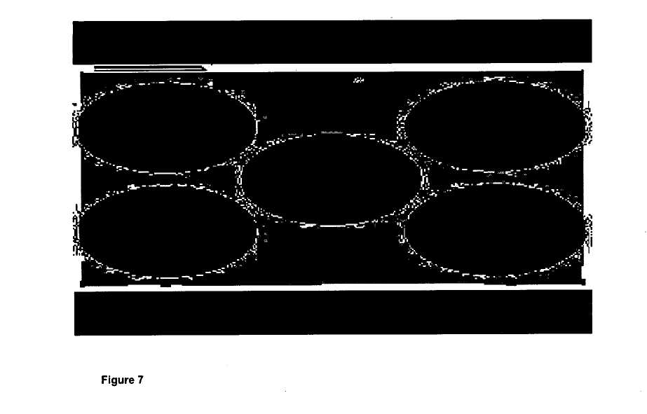

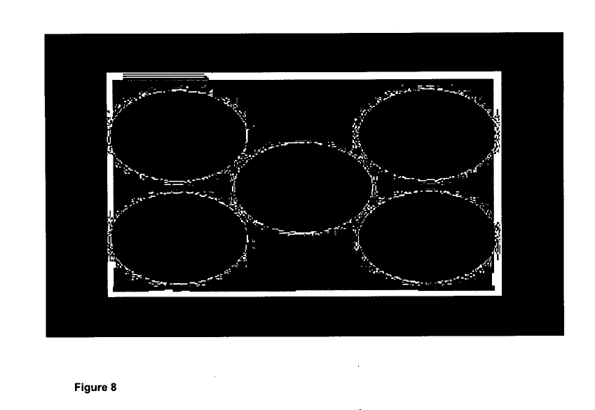

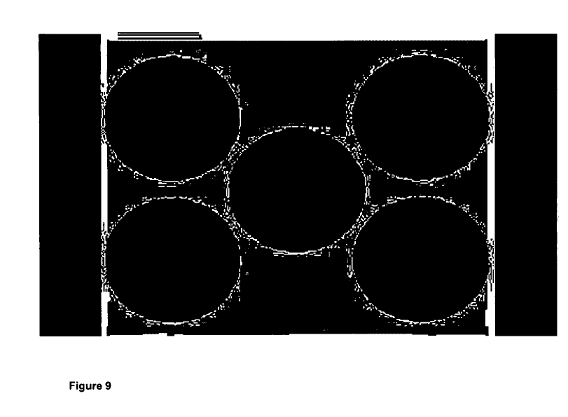

Metadata may be used for a plurality of purposes such as a stock ticker banner, an example of which is shown in FIG. 7. The example data shown in FIG. 7 may be sourced in real-time from a commercial site such as a stock broker's internet site or form the New York Stock Exchange. Another of the plurality of purposes of the metadata may be sourced in real-time from a commercial site such as www.weather.com for display of weather data, an example of which is shown in FIG. 8. Another of the plurality of purposes of the metadata may be either in real-time form a sponsor site for from an on-board file for such purposes as display of a company logo, an example of which is shown in FIG. 9.

In another embodiment, the user will have the capability to decide if metadata is to be displayed with a given video or static image and the nature and content of the metadata.

Color gradient patterns shown in FIGS. 2, 4, 6, 7, 8, and 9 are shown ranging from dark to light patterns from the top of the display screen descending toward the bottom of the display screen for side bars and from the top of the horizontal bar to the bottom of the horizontal bar. In another embodiment, the gradient pattern may vary from the outside edge of the bar to the inside edge closes to the center of the display screen. In another embodiment, the gradient pattern may vary from the edge of the bar closest to the center of the display screen to the edge of the bar closest to the outside edge of the display screen. In another embodiment, patterns other than color gradients may be substituted such as mottled patterns. In another embodiment, the color of the patterns surrounding the image or the color of the patterns to the left and right of the image or the color of the patterns above and below the image may be selected programmatically by a plurality of means such as a program's associated metadata to enhance the video content or the image being viewed.

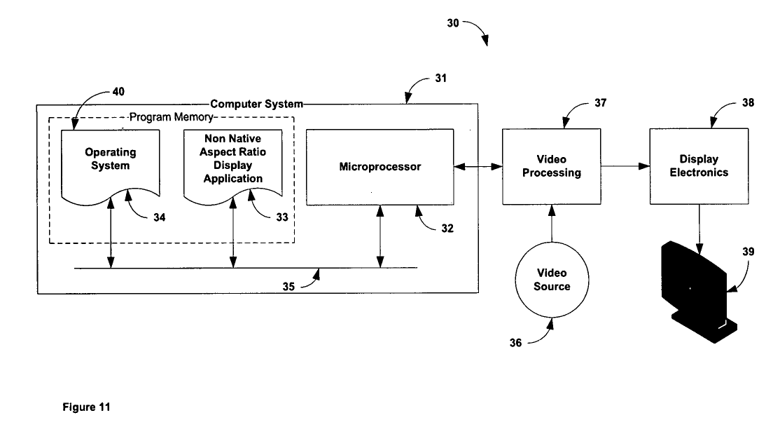

FIG. 11 shows an embodiment of the invention as 30, where computer system 31 manages the control of video processing 37. Computer system 31 consists of microprocessor 32 which interfaces with program memory over internal bus 35. Program memory 40 contains operating system 34 and a software application non 16:9 display application 33. Video processing 37 receives video and images from video source 36. Video source 36 is any of a plurality of video sources such as over the air broadcasts, set top boxes for cable and satellite services, a plurality of media players such as DVD and VCR players, and computer sourced video. When video processor 37 detects a non 16:9 aspect ratio image as the next image to be displayed, it notifies microprocessor 32. Microprocessor 32 will then execute non 16:9 display application 33 which follows the logic depicted in FIG. 10 and described above in the detailed description of FIG. 10.

Once non 16:9 images have the application of non-black padding bars added to said image video processing 37 send the image to display electronics 38 which in turn converts the output of video processing 37 to signals appropriate for display screen 39.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other ways of detecting non 16:9 video can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A digital television apparatus comprising:
a display screen;
a first computer system contained within said digital television system comprising:
a microprocessor;
a system memory;
said microprocessor operating to carry out first control logic, which determines display information that is not the same aspect ratio as a native aspect ratio of the display screen, said first control logic determining an padding area between said display information and perimeters of the display screen, and said microprocessor also operating to obtain metadata that is associated with said display screen and where said metadata is different than said display information; and
a video processing device producing an output for said display screen using said metadata to fill said padding area between said display screen and said perimeters of said digital display screen, said padding along with said display information forming a composite display information which is coupled to said display screen.

2. The apparatus of claim 1 where parts of said display in said padding area includes a single color gradient pattern of varying colors, and where said color is other than black.

3. The apparatus of claim 1 where said pattern is specified by metadata which is received with said display information.

4. The apparatus of claim 3 where said metadata sets a color of said pattern.

5. The apparatus of claim 1 where said metadata is embedded in a received video stream.

6. The apparatus of claim 1 where said metadata is obtained from software applications that access a database.

7. The apparatus of claim 6 where said metadata includes stock and/or commodity quotes in at least one of said padding areas.

8. The apparatus of claim 6 where said metadata includes weather forecasts in at least one of said padding areas.

9. The apparatus of claim 6 where said metadata includes logos of products or companies in at least one of said padding areas.

10. The apparatus of claim 5 where said video source is digital or analog television signals received from over the air broadcasters.

11. The apparatus of claim 5 where said received video stream is television signals received from a set top box.

12. The apparatus of claim 5 where said video source is from a media player.

13. The apparatus of claim 5 further comprising a metadata turn off part, allowing the viewer to cause metadata to be displayed or not to be displayed.

14. The apparatus of claim 5 further comprising a metadata control part, allowing where the viewer has the capability to select a type of metadata and a content of the metadata to be displayed.

15. The apparatus of claim 1, wherein said composite display information is one of a frame of a video or a static image.

16. A method comprising:
obtaining display information to be displayed on a display screen;
determining whether an aspect ratio of said display information differs from an aspect ratio of the display screen;
determining an padding area which will fill between said display information and perimeters of the display screen
obtaining filling data that is different than said display information that is associated with said display screen;
producing an output for said display screen using said metadata to fill said padding area between said display screen and said perimeters of said digital display screen, said padding along with said display information forming a composite display; and
displaying said information on said display screen.

17. The method of claim 16 where parts of said display in said padding area includes a single color gradient pattern of varying colors, and where said color is other than black.

18. The method of claim 16 further comprising receiving said display information over a channel, and receiving said metadata over said channel.

19. The method of claim 16 where said metadata sets a color of said pattern.

20. The method of claim 16 where said metadata is embedded in a received video stream.

21. The method of claim 18 where said metadata is obtained from software applications that access a database.

22. The method of claim 21 where said metadata includes stock and/or commodity quotes in at least one of said padding areas.

23. The method of claim 21 where said metadata includes weather forecasts in at least one of said padding areas.

24. The method of claim 21 where said metadata includes logos of products or companies in at least one of said padding areas.

25. The method of claim 18, further comprising allowing the viewer to prevent said metadata from being displayed.

26. The method of claim 18 further comprising allowing a viewer to select a type of metadata and a content of the metadata to be displayed.

27. A digital television apparatus comprising:
a first computer system, receiving a television signal, that has a processing part operating to determine whether said television signal represents display information that is the same aspect ratio as a native aspect ratio of an attached display, and said first computer system receiving data to be displayed in an area between said television signal and said attached display; and
a video processing device producing an output for said display screen using said data to fill said area.
